(19) United States
(12) Patent Application Publication
(10) Pub. No.: US 2012/0050924 A1
(43) Pub. Date: Mar. 1, 2012

(54) CURRENT COLLECTING BOX FOR PHOTOVOLTAIC POWER GENERATION

(75) Inventors: Takahisa MATSUO, Osaka (JP); Shuhei NISHIKAWA, Osaka (JP); Tsuyoshi SEKINE, Osaka (JP)

(73) Assignee: SANYO ELECTRIC CO., LTD., Moriguchi City (JP)

(21) Appl. No.: 12/862,267

(22) Filed: Aug. 24, 2010

(51) Int. Cl. H02H 9/08

(52) U.S. Cl. 361/42

(57) ABSTRACT

A current collecting box for collecting electric power from a plurality of photovoltaic strings comprising a detector providing a detection output for detection of ground fault in each of the photovoltaic strings, the detection output based on a differential current between a forward current cable and a backward current cable; a switch disposed in correspondence to each of the photovoltaic strings and interposed between the photovoltaic string and a connecting cable; and a control unit determining the presence of a ground fault based on the output from the detector and provides an on/off control of the switch according to the determination.

### BACKGROUND OF THE INVENTION

1. Field of the Invention

The present invention relates to a current collecting box for photovoltaic power generation. Particularly, the invention relates to a current collecting box for photovoltaic power generation employed by a photovoltaic power generation apparatus which comprises: a photovoltaic string including a plurality of photovoltaic modules; a current collecting box for collecting direct current power from the individual photovoltaic strings; and a power conditioner collecting the direct current power from the plural current collecting boxes and providing an output by converting the collected power to an alternating current power.

2. Description of the Prior Art

A photovoltaic cell generates direct current power by converting the natural energy into electrical energy. With increasing awareness of the recent environmental issues, a photovoltaic power generation apparatus has received attention as a clean power generation apparatus emitting no carbon dioxide which contributes to the global warming.

A large scale photovoltaic power generation system of current interest, such as a mega solar system, aims at achieving an output of more than 1000 kW and includes thousands of photovoltaic modules having an output on the order of 200 W and interconnected to form arrays.

By the way, the above-described photovoltaic power generation system may sometimes encounter a ground fault resulting from the deterioration of insulation performance of the photovoltaic modules, wirings or the like, which is induced by some factors including installation environment, usage condition and the like. In the event of a ground fault, it is necessary to locate a poorly insulated part and take an appropriate measure.

U.S. Pat. No. 6,593,520 discloses a photovoltaic power generation apparatus having photovoltaic strings arranged such that in the event of a ground fault in part of a photovoltaic array, only a failed photovoltaic string is disconnected from the photovoltaic power generation apparatus. This way, the operation of the photovoltaic power generation apparatus as a whole is not suspended.

This photovoltaic power generation apparatus includes a current collecting box for collecting output electricity from a plurality of photovoltaic strings where each of the photovoltaic strings has a plurality of photovoltaic panels connected in series. The current collecting box includes: a detector for sending a failure detection signal upon detection of a failure in any one of the plural photovoltaic strings; an intermediate switch that shifts to an open state upon receiving the failure detection signal from the detector; and string switches capable of disconnecting respective photovoltaic strings. The string switch is configured to shift to an open state upon receiving the failure detection signal.

This photovoltaic power generating device is for domestic use and hence, the current collecting box is installed inside the house so that an inspection operation is relatively easy.

### SUMMARY OF THE INVENTION

However, as the photovoltaic power generation apparatus is increased in size, the number of current collecting boxes is also increased. Further, installation sites also become diverse. What is more, the distance between the current collecting box and the power conditioner is also increased, resulting in the increase in the length and the number of cables interconnecting these components.

In view of the foregoing problem, the invention seeks to provide a device capable of proper detection of a ground fault which may occur in a photovoltaic power generation apparatus of a larger scale than the apparatus for domestic use.

According to the invention, a current collecting box for photovoltaic power generation serving to collect electric power from a plurality of photovoltaic strings, the current collecting box comprises: a detector for detecting a ground fault in each of the photovoltaic strings; a switch provided in correspondence to each of the photovoltaic strings and interposed between the photovoltaic string and a connecting cable; and a control unit applying an on-off control to the switch according to a detection result supplied from the detector, wherein upon detection of a ground fault by the detector, the control unit switches off the switch of the corresponding photovoltaic string so as to break connection between the photovoltaic string and the connecting cable.

According to the invention, as described above, in the event of a ground fault, the control unit of the current collecting box for photovoltaic power generation breaks the connection between the photovoltaic string and the connecting cable so that a suitable ground-fault recovery process can be carried out on a case-by-case basis.

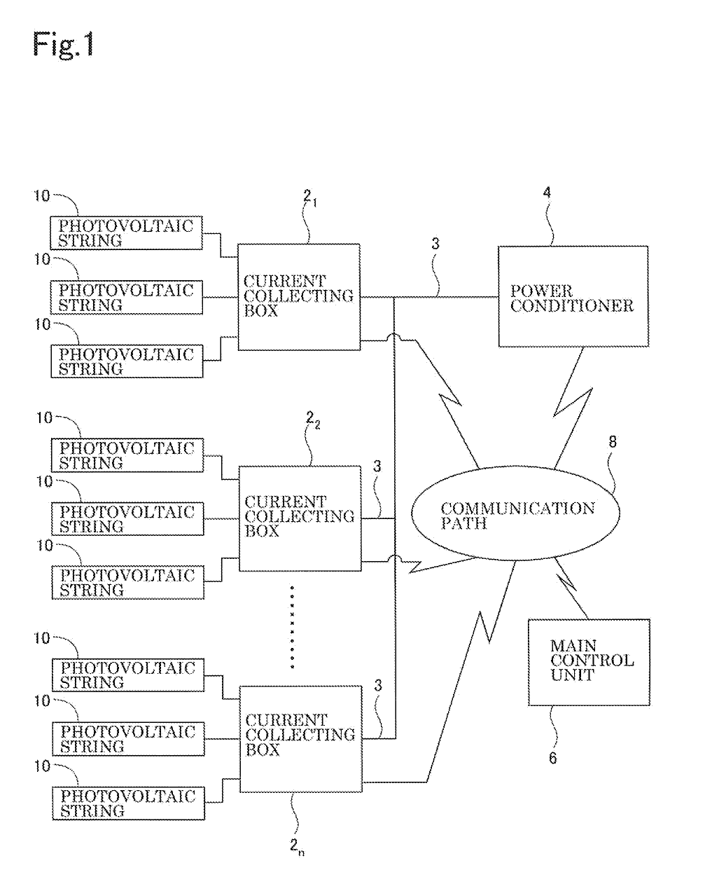

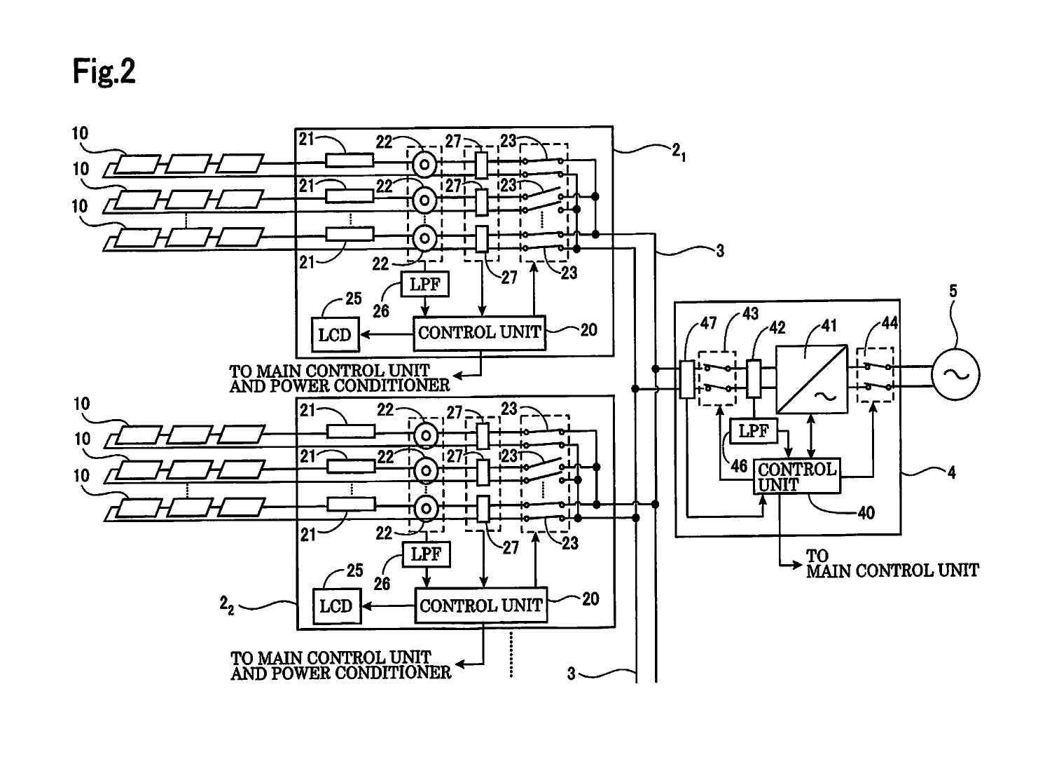

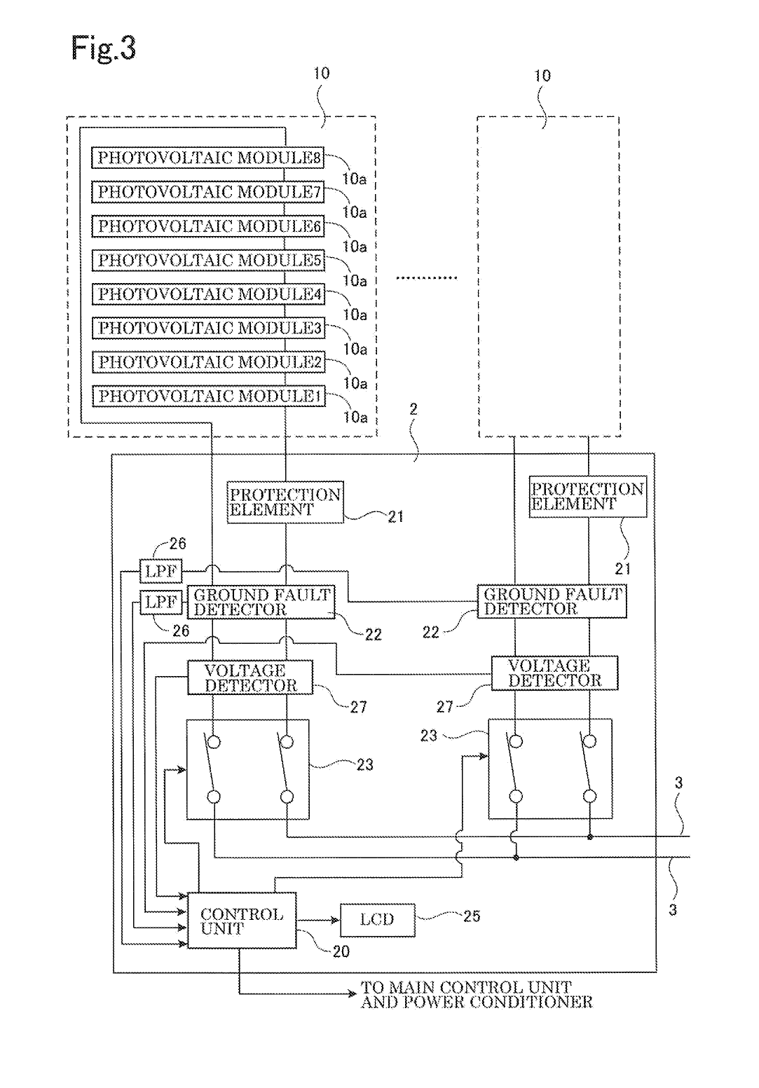

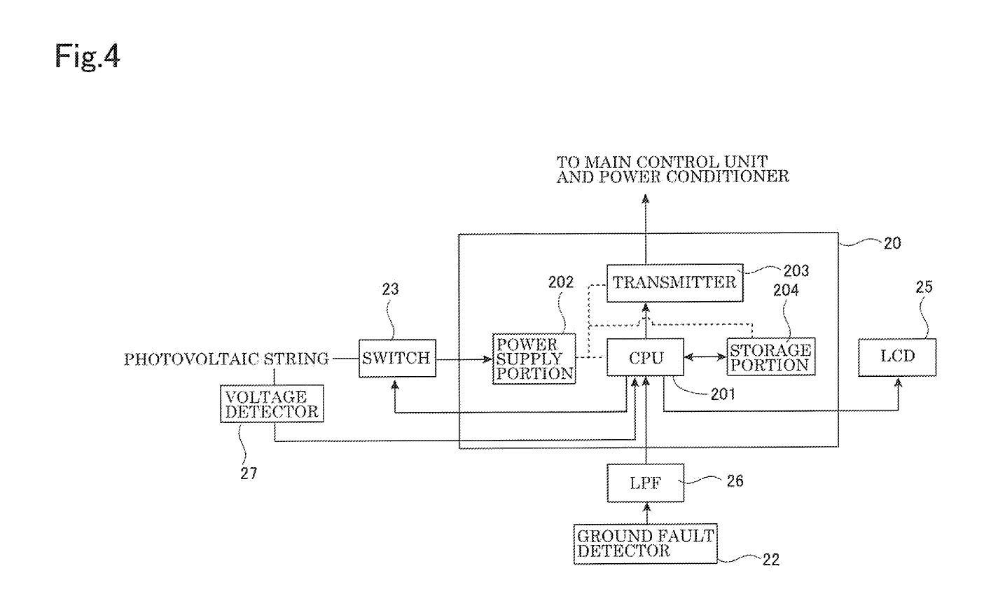

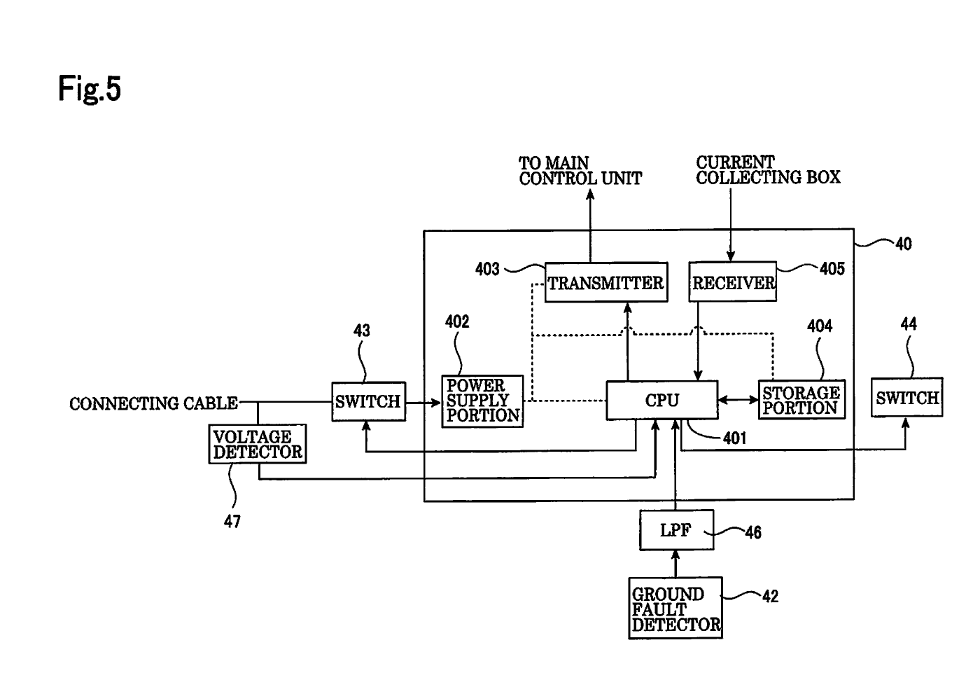

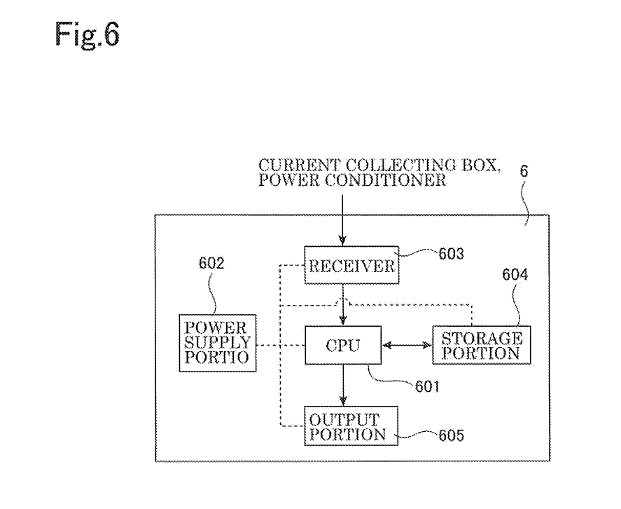

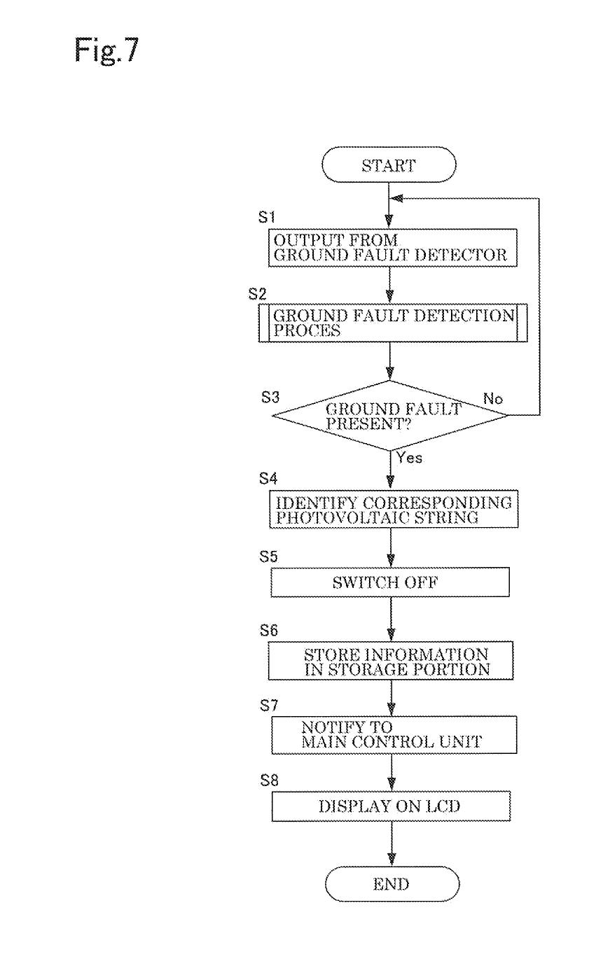

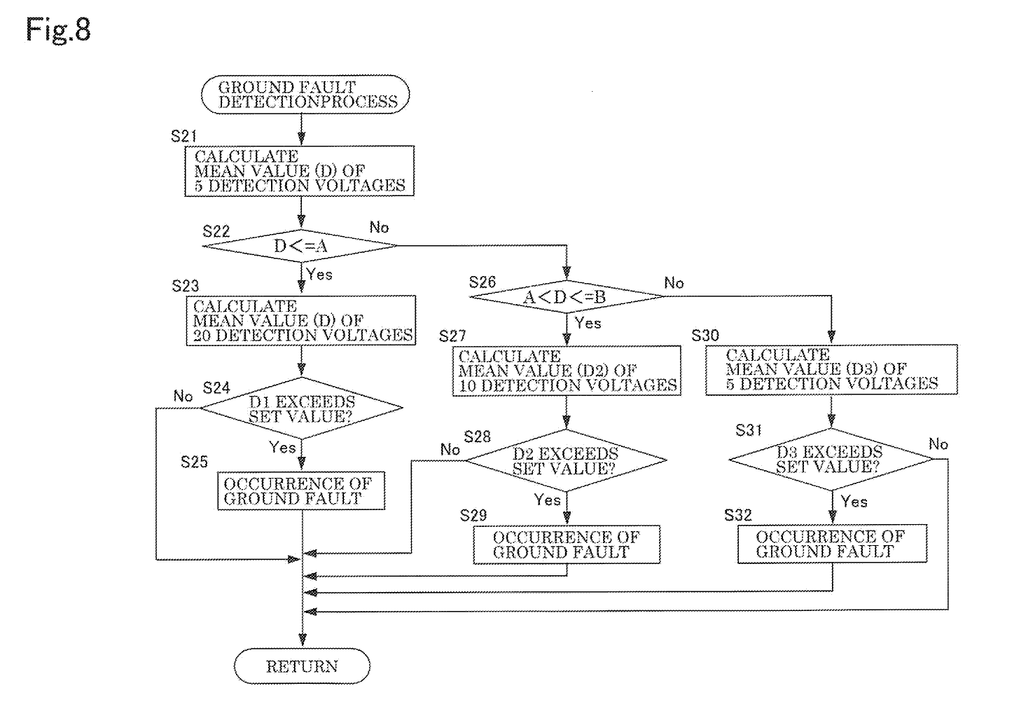

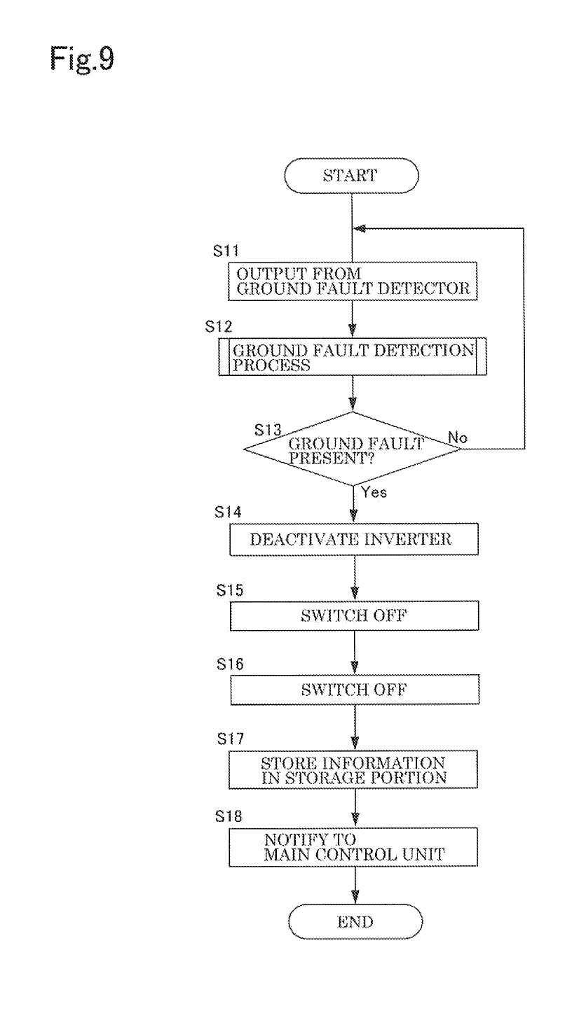

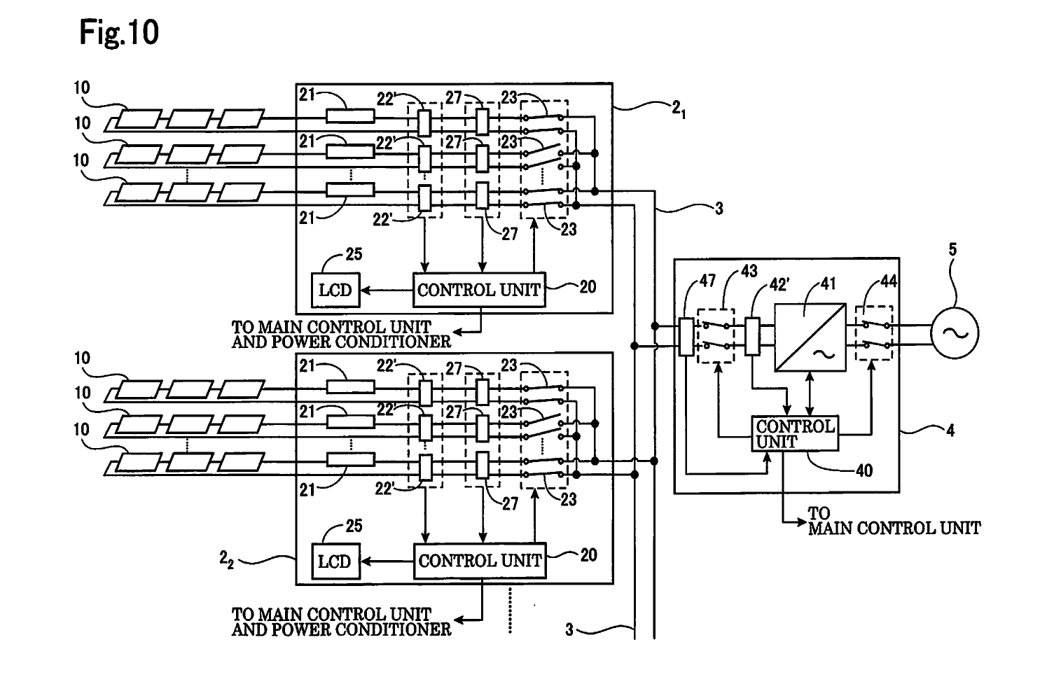

### BRIEF DESCRIPTION OF THE DRAWINGS

[FIG. 1] A schematic diagram showing a general arrangement of a photovoltaic power generation apparatus according to an embodiment of the invention;

[FIG. 2] A schematic diagram showing a principal arrangement of the photovoltaic power generation apparatus according to the embodiment of the invention;

[FIG. 3] A schematic diagram showing the detail of a part including photovoltaic strings and a current collecting box according to the embodiment of the invention;

[FIG. 4] A functional block diagram of a control unit of the current collecting box of the photovoltaic power generation apparatus according to the embodiment of the invention;

[FIG. 5] A functional block diagram showing a configuration of a main control unit having a function to record ground fault information;

[FIG. 6] A flow chart showing the steps of a ground fault detection process performed by the control unit of the current collecting box of the photovoltaic power generation apparatus according to the embodiment of the invention;

[FIG. 7] A flow chart showing the steps of a ground fault detecting routine performed by a control unit of the photovoltaic power generation apparatus according to the embodiment of the invention;

[FIG. 8] A flow chart showing the steps of a ground fault detecting routine performed by the control unit of the photovoltaic power generation apparatus according to the embodiment of the invention;

[FIG. 9] A flow chart showing the steps of a ground fault detection process performed by a control unit of a power conditioner in the photovoltaic power generation apparatus according to the embodiment of the invention; and

[FIG. 10] A schematic diagram showing a principal arrangement of a photovoltaic power generation apparatus according to another embodiment of the invention.

A flow chart showing the steps of the ground fault detection process performed by the control unit of the power conditioner in the photovoltaic power generation apparatus according to the embodiment of the invention.

The foregoing and other objects, features, aspects and advantages of the present invention will become more apparent from the following detailed description of the present invention when reviewed in conjunction with the accompanying drawings.

### DETAILED DESCRIPTION OF THE PREFERRED EMBODIMENTS

The preferred embodiments of the invention will be described in detail with reference to the accompanying drawings. It is noted that identical or equivalent elements in the drawings will be referred to by like reference numerals and will be explained only once to avoid repetition.

FIG. 1 is a schematic diagram showing a general arrangement of a photovoltaic power generation apparatus according to the invention. FIG. 2 is a schematic diagram showing a principal arrangement of the photovoltaic power generation apparatus according to the invention. FIG. 3 is a schematic diagram showing the detail of a part including photovoltaic strings and a current collecting box.

The photovoltaic power generation apparatus according to the embodiment constitutes a medium-scale system wherein tens of photovoltaic modules having an output on the order of 200 W are interconnected, or a mega solar system wherein at least thousands of such photovoltaic modules are interconnected. The photovoltaic power generation apparatus comprises a photovoltaic string 10 including a plurality of photovoltaic modules 10a connected in series. A current collecting box 2 is connected with a plurality of photovoltaic strings 10 so as to collect direct current outputs from the individual photovoltaic strings 10. Outputs from the plural current collecting boxes 2 (2₁ to 2ₙ) are supplied to a power conditioner 4 via a connecting cable 3. Direct current power generated by photovoltaic cells is converted into alternating current power by an inverter 41 disposed in the power conditioner 4. Harmonic components are removed from the alternating current power by an unillustrated noise filter and the resultant alternating current power is outputted to a system 5. While FIG. 1 shows only one power conditioner 4, an alternative arrangement may be made according to the configuration or scale of the apparatus such that more than one conditioner is employed for supplying the electric power to the system 5.

In a case where some failure such as a ground fault arises in any one of the photovoltaic strings 10 connected to the current collecting box 2, a control unit 20 in the current collecting box 2 notifies a main control unit 6, disposed in a power management room or the like, of the occurrence of the failure via a communication path 8 constituted by a network such as LAN. The communication path 8 is built properly in any one of modes that meets the need, the modes including wireless communications, cable communications and the like.

In a case where some failure such as a ground fault arises at the connecting cable 3 from the current collecting box 2 to the power conditioner 4, a control unit 40 in the power conditioner 4 notifies the main control unit 6 of the failure occurrence via the communication path 8. The components shown in FIG. 1 to FIG. 3 are sequentially described as below.

As shown in FIG. 3, the photovoltaic string 10 comprises a plurality of photovoltaic modules 10a connected in series. While this figure shows the configuration of one photovoltaic string 10, the other photovoltaic strings are configured the same way. In this embodiment, the photovoltaic string 10 consists of eight photovoltaic modules 10a connected in series, each having an output on the order of 200 W. The photovoltaic string 10 supplies an output to the current collecting box 2. The number of series-connected photovoltaic modules 10a is not limited to eight but may be varied properly to permit the photovoltaic power generation apparatus to achieve a required voltage.

The photovoltaic module 10a comprises an array of photovoltaic cells which are connected in series by means of a wiring member and are sealed between a surface member such as glass and a weather resistant backside member with a translucent sealing material such as EVA (ethylene vinylacetate) having excellent weather resistance and moisture resistance. Examples of a usable photovoltaic cell include a variety of photovoltaic cells such as crystalline photovoltaic cells, thin film photovoltaic cells and compound photovoltaic cells.

Outputs from the plural photovoltaic strings 10 of the above configuration are connected to the current collecting box 2. The number of photovoltaic strings 10 connected to one current collecting box 2 is selected properly so as to permit the photovoltaic power generation apparatus to achieve a required output.

The plural photovoltaic strings 10 are connected in parallel to the current collecting box 2 which collects the outputs from the photovoltaic strings 10. The current collecting box 2 is installed at place accessible to a checker in proximity of the location of the plural photovoltaic strings 10 in order to reduce the length of the cable between the photovoltaic strings 10 and the current collecting box 2. If any failure such as a ground fault arises in the photovoltaic string 10 connected to the current collecting box 2, the failure occurrence is notified to the main control unit 6 in the power management room or the like via the communication path 8 comprising a network such as LAN. The information to be notified includes, for example, information identifying a current collecting box 2, information identifying a photovoltaic string 10 suffering a failure such as ground fault, information on a date of occurrence of a ground fault and the like. The current collecting boxes 2 and the photovoltaic strings 10 are assigned with respective ID numbers for identification in advance. The information is sent along with the ID number to the main control unit 6 via the communication path 8. Such an arrangement allows the main control unit 6 to easily identify a current collecting box 2 or photovoltaic string 10 that is affected by a failure caused by a ground fault or the like. The current collecting box 2 further outputs information on output voltages from the individual photovoltaic strings 10 and on/off states of individual switches 23. The information is supplied to the power conditioner 4 via the communication path 8 so that the power conditioner 4 can acquire information on the output voltages from the individual photovoltaic strings 10 and the on/off status of the individual switches 23.

In the current collecting box 2, the switch 23 is provided in one-on-one correspondence to the photovoltaic string 10 so as to disconnect the corresponding photovoltaic string 10 from the circuit when the photovoltaic modules 10a and the like are given a maintenance check, or when some failure such as ground fault arises in a part of the photovoltaic string 10. An on/off control of the switch 23 is provided by the control unit 20 constituted by a microcomputer or the like. The switch 23 is capable of carrying and breaking the maximum current the photovoltaic string can supply and is electrically opened and closed. When the switch 23 is in an on state, namely, when the switch 23 is supplied with electric power from the photovoltaic string 10, an on-current is passed through the switch 23 which is maintained in a closed position. When the switch 23 is in an off state, namely, when the power supply thereto is cut off, a control is provided to cut off the power supply to the switch 23 which is maintained in an open position. The switch 23 comprises an electromagnetic relay which is on/off switchable by a signal from the control unit 20. As described above, the switch 23 is on when supplied with the electric power, but is off when the power supply thereto is cut off. According to the embodiment, therefore, the switch 23 is maintained in the off state during the night when the electric power is not supplied thereto. Thus, the embodiment achieves power saving during the nighttime period when the photovoltaic strings do not generate the electric power.

Each photovoltaic string 10 is provided with protection elements 21 such as a fuse, a backflow protection diode, and the like. The protection element serves to prevent current backflow resulting from different voltages generated in the individual photovoltaic strings 10 due to different installation positions of the photovoltaic strings 10 or different sunlight radiation conditions.

A ground fault detector 22 for ground fault detection is interposed between a respective pair of switch 23 and photovoltaic string 10. The ground fault detector 22 detects a differential current between a forward current cable and a backward current cable based on magnetic fields generated in these cables and applies a detection signal to the control unit 20. The detection signal is superimposed with noises of the cable from the photovoltaic string 10 and the like. In order to avoid a noise-induced malfunction of the detection signal, the embodiment is arranged such that a detection output from the ground fault detector (ground fault detector portion) 22 is subjected to a lowpass filter (LPF) 26 for removal of the noise component before inputted to the control unit 20. The control unit 20 is supplied with a set voltage (P) such that the control unit may refer to the set value and the output from the ground fault detector 22 to determine whether a ground fault is present or not. Detection sensitivity depends upon this set voltage (P). The set voltage (P) is set in consideration of the system, carried current and the like. The control unit 20 determines that a ground fault is present when a detection output from the ground fault detector 22 exceeds the set voltage (P). Instead of utilizing the magnetic field, the ground fault detector 22 may employ a clamp-on current sensor for detecting the differential current.

If the control unit 20 determines the presence of a ground fault based on one detection output inputted thereto from the ground fault detector 22, the control unit may make a false detection due to unexpected noises or the like. According to the embodiment, therefore, the control unit is configured to calculate the mean value of plural detection values inputted thereto and to determine the presence of the ground fault by comparing the mean value with the above-described set voltage (P). For this purpose, the control unit 20 fetches the detection outputs from the ground fault detector 22 at one-second intervals, for example, and stores a predetermined number of detection outputs so as to calculate the mean value thereof. Then, the control unit compares the mean value with the set voltage (P). This control operation will be described hereinlater.

In spite of the absence of the ground fault, the detection value outputted from the ground fault detector 22 progressively increases with the deterioration of the cable and the like. According to the embodiment, therefore, the detection sensitivity is adjusted by varying the number of detection signals to be averaged depending upon the value of detection output. For instance, each time the detection output value increases, the detection sensitivity is increased by reducing the number of detection outputs to be averaged.

In a case where the detection sensitivity is maximized due to the increase in the detection output value, the ground fault is more likely to occur. Therefore, an arrangement may be made such that a message prompting maintenance work is given according to the value of detection output. These control operations will be described hereinlater.

Detecting the occurrence of a ground fault, the control unit 20 switches off the switch 23 connected to the photovoltaic string 10 suffering the ground fault, namely provides control to break the circuit. The control unit 20 cuts off the power supply to the corresponding switch 23 so as to switch off the same. The switch 23 is controlled by the control unit 20 so as to cut off the power supply from the photovoltaic string 10 suffering the ground fault.

The control unit 20 stores, in an internal storage device thereof, information concerning the occurrence of ground fault and the photovoltaic string 10 suffering the ground fault and displays the information on a display unit 25 comprising a liquid crystal display (LCD) or the like. The control unit also sends information to the main control unit 6 via the communication path 8, wherein the information concerns the current collecting box 2, the occurrence of ground fault and the photovoltaic string 10 suffering the ground fault.

The control unit 20 is supplied with an output voltage of each photovoltaic string 10 via a voltage detector circuit 27. Assuming that Vₚₙ represents a photovoltaic voltage from the photovoltaic string 10, the control unit 20 provides the on/off control of the switch 23 by checking the voltage Vₚₙ. Specifically, the switch 23 need be maintained in the on state while the inverter 41 is operative. The switch 23 is switched on before the inverter 41 is activated. Assuming that V1 represents a startup voltage of the after-mentioned inverter 41, V2 represents a shutdown voltage thereof and Vₚₙ represents a photovoltaic voltage from the photovoltaic string 10, the control unit 20 provides the on/off control of the switch 23 by checking the voltage Vₚₙ. Specifically, the control unit holds the switch 23 in the on state during the operation of the inverter 41. The switch 23 is switched on prior to the activation of the inverter 41.

An on-condition for the switch 23 is defined as Vₚₙ>= (is equal to or more than) V1−50V, where “50V” is merely exemplary and varies depending upon the system.

An off-condition for the switch 23 is defined as continuation of a state Vₚₙ<= (is equal to or less than) V2−50V for 30 minutes. This is because the photovoltaic voltage is not necessarily decreased to 0V depending upon the installation environment of the photovoltaic cells. The above values, 30 minutes and 50V, are merely exemplary and vary depending upon the system.

Besides the ground fault process, the control unit 20 also checks the voltage Vₚₙ supplied from the photovoltaic string 10 and provides the on/off control of the switch 23 when the voltage Vₚₙ satisfies the above condition.

FIG. 4 is a functional block diagram showing a configuration of the control unit 20 in the current collecting box 2. The control unit 20 comprises a microcomputer which contains a CPU (Central Processing Unit) 201, a transmitter 203 and a storage portion 204 including a ROM (Read Only Memory) and a RAM (Random Access Memory). The ROM of the storage portion 204, for example, contains programs for controlling the operations of the current collecting box 2 which include the ground fault detection, the on/off control of the switch 23 and the like. In the event of a ground fault, the CPU 201 executes programs for implementing a calculator function to calculate the mean value of the outputs from the ground fault detector portion 22, implementing a judgment maker function to determine the presence of the ground fault by comparing the mean value with a set value, identifying the photovoltaic string 10 corresponding to the ground fault, cutting off the power supply to the switch 23 and transmitting the failure signal, and controls the individual operations. The transmitter 203 transmits various information items to the main control unit 6 via the communication path 8.

The current collecting box 2 is provided with a power supply portion 202. When the electric power is supplied from the photovoltaic strings 10 via the switches 23, a part of the electric power is supplied to the power supply portion 202. The power supply portion 202 is supplied with electric power from the system 5 when the photovoltaic strings 10 do not supply the electric power. The power supply portion 202 supplies the electric power to the CPU 201, transmitter 203, storage portion 204 and the like. This power supply portion 202 is equipped with a secondary battery which is charged with the supplied electric power. This way, the operation of the control unit 20 can be carried out even when the photovoltaic strings 10 do not generate the electric power.

When detecting a ground fault or the like, the control unit 20 transmits from the transmitter 203 to the communication path 8, an ID number assigned for the identification of current collecting box 2 and the information concerning the photovoltaic string 10 suffering the ground fault, the communication path 8 in turn sends the ID number and the information to the main control unit 6. The display unit 25 displays information for the identification of the photovoltaic string 10 suffering the ground fault and information indicating the time of ground fault occurrence and the like. The transmitter 203 of the current collecting box 2 further outputs the output voltage of each photovoltaic string 10 and on/off information on each switch 23. The information items are supplied to the power conditioner 4 via the communication path 8 so that the power conditioner 4 can acquire the output voltage of each photovoltaic string 10 and the on/off information on each switch 23.

As shown in FIG. 1 and FIG. 2, the power conditioner 4 is supplied with the electric power from the plural current collecting boxes 2₁ to 2ₙ via the connecting cables 3. The power conditioner 4 supplies the electric power from the connecting cables 3 to the inverter 41 via a switch 43 and a ground fault detector 42. The inverter 41 converts the supplied direct current power into the alternating current power. The inverter 41 outputs the alternating current power to the system 5 via a switch 44. The on/off state of the switches 43, 44 is controlled by the control unit 40. As described above, the plural photovoltaic strings 10 are connected to the current collecting box 2, and the plural current collecting boxes 2 are connected to the power conditioner 4. The numerical relations of these components is expressed as photovoltaic strings 10>current collecting boxes 2>power conditioner 4. That is, the number of the photovoltaic strings 10 is the largest and the number decreases in the descending order of the current collecting box 2 and the power conditioner 4. Incidentally, the switch 42 may be disposed externally of the power conditioner 4.

The ground fault detector 42 for ground fault detection is interposed between the switch 43 and the inverter 41. The ground fault detector 42 detects the differential current between the forward current cable and the backward current cable based on the magnetic fields generated in these cables and applies the detection signal to the control unit 40. The detection signal is superimposed with the noises of the connecting cable 3 and the like. In order to avoid the noise-induced malfunction of the detection signal, the embodiment is arranged such that an output from the ground fault detector 42 is subjected to a lowpass filter 46 for removal of the noise component before inputted to the control unit 40. The control unit 40 is supplied with the set voltage (P) such that the control unit may refer to the set voltage and the output from the ground fault detector 42 to determine whether the ground fault is present or not. The detection sensitivity depends upon this set voltage (P). The set voltage (P) need be set in consideration of the noises. The ground fault detector used in the current collecting box 2 and the ground fault detector used in the power conditioner 4 have different noises superimposed on the lines connected thereto because the lines led thereto have different lengths and locations. Because of the different noises, the set voltage (P), which corresponds to the detection sensitivity defined in consideration of the noises, differs between the control units 20, 40.

The line from the current collecting box 2 to the power conditioner 4 is normally longer than the line from the photovoltaic string 10 to the current collecting box 2. Further, the noises superimposed on the connecting cable 3 connected to the power conditioner 4 is of the greater magnitude. According to the embodiment, therefore, the control unit 40 has the lower ground fault detection sensitivity than the control unit 20 of the current collecting box 2 because the ground fault detection with high sensitivity may lead to a noise-induced false detection of ground fault.

Based on the output from the ground fault detector 42, the control unit 40 can determine whether or not a ground fault is present between the current collecting box 2 and the power conditioner 4. Instead of utilizing the magnetic field, the ground fault detector 42 may employ a clamp-on current sensor for detecting the differential current.

If the control unit 40 determines the presence of a ground fault based on one detection output inputted thereto from the ground fault detector 42, the control unit may make a false detection due to unexpected noises or the like. According to the embodiment, therefore, the control unit is configured to calculate the mean value of plural detection values inputted thereto and to determine the presence of the ground fault by comparing the mean value with the above-described set voltage (P). For this purpose, the control unit 40 has a calculator function and a judgment maker function to determine the presence of the ground fault. The control unit 40 fetches the detection outputs from the ground fault detector 42 at one-second intervals, for example, and stores a predetermined number of detection outputs so that the calculator calculates the mean value of these outputs. Then, the judgment maker compares the mean value with the set voltage (P). This control operation will be described hereinlater. In spite of the absence of the ground fault, the detection value outputted from the ground fault detector 42 progressively increases with the deterioration of the cable and the like. According to the embodiment, therefore, the detection sensitivity is adjusted by varying the number of detection signals to be averaged depending upon the value of the detection output. For instance, each time the detection output value increases, the detection sensitivity is increased by reducing the number of detection outputs to be averaged.

In a case where the detection sensitivity is maximized due to the increase of the detection value, the ground fault is more likely to occur. Therefore, an arrangement may be made such that a message prompting maintenance work is given according to the value of detection output.

Upon detecting the occurrence of a ground fault based on the detection signal from the ground fault detector 42, the control unit 40 switches off the switch 43 connecting the inverter 41 with the connecting cable 3, and the switch 44 connecting the inverter 41 with the system 5, namely cuts off the power supply to the switches 43, 44 so as to break the circuit. When supplied with the electric power, the switches 43, 44 are switched on so as to maintain the electrical connection. When the power supply to the switches 43, 44 is cut off, the switches 43, 44 are switched off acting to break the electrical connection.

Upon detection of the ground fault, the control unit 40 stops controlling the inverter 41 and deactivates the same. Subsequently, the control unit switches off the switch 44 to break the electrical connection between the power conditioner 4 and the system 5. Then, the control unit switches off the switch 43 to break the electrical connection between the inverter 41 and the connecting cable 3. The control unit 40 stores information concerning the occurrence of the ground fault in the internal storage device thereof and also sends such information to the main control unit 6 via the communication path 8.

The control unit 40 applies PWM control to switching elements constituting the inverter 41 such that the system 5 is supplied with an alternating current power having a predetermined voltage and a predetermined frequency. The inverter 41 is activated by inputting a PWM signal from the control unit 40 and deactivated by cutting off the supply of the PWM signal. The inverter 41 is activated when a voltage inputted from the connecting cable 3 is greater than a reference voltage. Hence, the control unit 40 is supplied with the voltage from the connecting cable so as to compare the input voltage to the inverter 41 with the reference voltage. If the input voltage is greater than the reference voltage, the control unit applies the PWM signal to the inverter 41 to activate the same. When the input voltage or power falls below a predetermined value, the control unit 40 cuts off the supply of PWM signal to deactivate the inverter 41. The predetermined value means a preset value of voltage required for operating the inverter 41. When the inverter 41 is inactive, the control unit 40 switches off (open position) the switch 44 to break the electrical connection between the inverter 41 and the system 5. The apparatus is adapted to achieve power saving by switching off the switches 43, 44 during the nighttime period or the like when the photovoltaic strings 10 do not generate the electric power. A power supply to the ground fault detector 42 is also stopped.

Assuming that V1 represents a startup voltage of the inverter 41, V2 represents a shutdown voltage thereof and Vₚₙ represents a photovoltaic voltage supplied to the inverter 41 via the connecting cable 3, the control unit 40 provides the on/off control of the switches 43, 44 by checking the voltage Vₚₙ. Specifically, the switches 43, 44 need to be maintained in the on state during the operation of the inverter 41. The control unit 40 is supplied with information from the current collecting boxes 2 via the communication path 8, wherein the information indicates the output voltages from the photovoltaic strings 10 and the on/off control of the switches 23. In a case where none of the switches 23 of all the current collecting boxes 2 is switched on, the control unit 40 maintains the switch 43 in the off state.

As described above, the on-condition for the switches 43, 44 is defined as Vₚₙ>= (is equal to or more than) V1−50V, where “50V” is merely exemplary and varies depending upon the system.

As described above, the off-condition for the switches 43, 44 is defined as continuation of the state Vₚₙ<= (is equal to or less than) V2−50V for 30 minutes. This is because the photovoltaic voltage is not necessarily decreased to 0V depending upon the installation environment of the photovoltaic cells. The above values 30 minutes and 50V are merely exemplary and vary depending upon the system.

Besides the activation process and the ground fault process, the control unit 40 also checks the voltage Vₚₙ of the photovoltaic string 10 supplied via the connecting cable 3 and provides the on/off control of the switches 43, 44 when the voltage Vₚₙ satisfies the above condition.

The control unit 40 is provided with a power supply portion. When the electric power is supplied from the photovoltaic strings 10, a part of the supplied electric power is supplied to the power supply portion. The power supply portion is supplied with electric power from the system 5 when the photovoltaic strings 10 do not supply the electric power. The power supply portion may be provided with a secondary battery which is charged with the electric power from either the photovoltaic strings 10 or the system 5. The power supply portion may be adapted to apply the charged power to the operation of the control unit 40 and the like.

The control unit 40 performs the activation process for activating the inverter 41. The activation process is started at sunrise, for example, when the photovoltaic strings 10 start receiving the sunlight. The activation process is also performed in a case where the inverter 41 is inactive during a period when the photovoltaic strings 10 can be subjected to the sunlight, namely a case where, for example, the sunlight is temporarily blocked to disable the photovoltaic strings 10 to output the electric power. The activation process is performed as follows. When the photovoltaic voltage Vₚₙ supplied to the control unit 40 satisfies the above condition, the control unit first switches on the switch 43. When the photovoltaic voltage Vₚₙ reaches V1, the control unit activates the inverter 41 and switches on the switch 44 to make the electrical connection with the system 5.

The control unit 40 also performs a deactivation process for deactivating the inverter 41. The deactivation process except for deactivation caused by a ground fault is started at sunset, for example, when the photovoltaic strings 10 are not irradiated with the sunlight any more. The deactivation process is also performed in a case where the output from the photovoltaic strings 10 is lowered during the period when the photovoltaic strings 10 can be subjected to the sunlight. When the photovoltaic voltage Vₚₙ reaches V2, the inverter 41 becomes inactive. Then, the switch 44 is switched off. At this time, the switch 43 is in the on state. This is because the control unit does not immediately respond to a temporary voltage fluctuation to cut off the power supply to the inverter 41. When the photovoltaic voltage Vₚₙ satisfies the above condition, the control unit switches off the switch 43.

Upon detection of the ground fault, the control unit 40 immediately performs the deactivation process. The control unit stops controlling the inverter 41 and deactivates the same. Subsequently, the control unit switches off the switch 44 to break the electrical connection between the power conditioner 4 and the system 5 for ensuring safety. Then, the control unit switches off the switch 43 to break the electrical connection between the inverter 41 and the connecting cable 3. The control unit 40 stores information concerning the occurrence of the ground fault in the internal storage device thereof and also sends such information to the main control unit 6 via the communication path 8.

FIG. 5 is a functional block diagram showing a configuration of the control unit 40 in the power conditioner 4. The control unit 40 comprises a microcomputer which contains a CPU (Central Processing Unit) 401, a transmitter 403, a receiver 405 and a storage portion 404 including a ROM and a RAM. The ROM of the storage portion 404, for example, contains programs for controlling the operations of the power conditioner 4 which include the detection of ground fault, the on/off control of the switches 43, 44, the drive/control of the inverter 41 and the like. In the event of a ground fault, the CPU 401 executes programs for detecting the ground fault, deactivating the inverter 41, switching off the switches 43, 44, and transmitting a failure signal, and controls the individual operations. The transmitter 403 sends various information items to the main control unit 6 via the communication path 8. The receiver 405 receives via the communication path 8 information items concerning the output voltages of the photovoltaic strings 10 and the on/off states of the switches 23 in the current collecting boxes 2. These information items are supplied to the CPU 401 and used for the control of the inverter 41. The control unit 40 is supplied with the output voltages of the photovoltaic strings 10 by means of a voltage detector 47. The output from the ground fault detector 42 is subjected to the lowpass filter (LPF) 46 for removal of the noise components before inputted to the control unit.

The control unit 40 is provided with a power supply portion 402. The power supply portion 402 is connected to the connecting cable 3 so as to be supplied with a part of the electric power generated by the photovoltaic strings 10. The power supply portion 42 supplies the electric power to the CPU 401, transmitter 403, receiver 405, storage portion 404 and the like. This power supply portion 402 is equipped with a secondary battery which is charged with the electric power supplied thereto. The power supply portion is adapted to ensure the operation of the control unit 20 even when the photovoltaic strings 10 do not generate the electric power.

Upon detection of the ground fault, the control unit 40 transmits from the transmitter 403 to the communication path 8 an ID number assigned for identification of power conditioner 4 and information indicating date and time of occurrence of the ground fault and the like. The communication path 8 in turn sends the ID number and the information to the main control unit 6.

FIG. 6 is a functional block diagram showing a configuration of the main control unit 6 having a function to record information on ground fault occurrence. The main control unit 6 is communicably connected to the plural current collecting boxes 2 and one or more power conditioners 4 via the communication path 8. As shown in the figure, the main control unit 6 includes a CPU 601, a power supply portion 602, a receiver 603, a storage portion 604 and an output portion 605.

The receiver 603 receives notification data from the individual current collecting boxes 2 and the power conditioner(s) 4 via the communication path 8 and supplies the received data to the CPU 601. The storage portion 604 contains programs for executing the operations of the main control unit and also stores the ID numbers, measurement date and results of the current collecting boxes 2 and the power conditioner(s) 4, which are contained in the notification data.

The CPU 601 stores the received data in the storage portion 604 and supplies failure-related information such as ground fault to the output portion 605.

The output portion 605 outputs the ground fault information to the liquid crystal display (LCD) and a speaker. A maintenance worker can find out which of the current collecting boxes 2 or the power conditioners 4 suffers the ground fault by referring to the information displayed on an output device 605 of the main control unit 6. The power supply portion 602 supplies the electric power to the CPU 601, receiver 603, storage portion 604, output portion 605 and the like. This power supply portion 602 may be equipped with a secondary battery.

An area requiring the maintenance work can be identified by referring to the above-described information displayed on the output portion 605. The maintenance worker can perform the job at the current collecting box 2 or power conditioner 4 which suffers the ground fault. The display unit 25 of the current collecting box 2 displays information on the photovoltaic string 10 suffering the ground fault and the on/off state of the switch 23 connected to this photovoltaic string 10. The worker can go on with his job according to the displayed information thereby safely and quickly accomplishing the replacement of the photovoltaic string 10.

Next, a ground-fault detection process by the control unit 20 of the current collecting box 2 according to the invention is described with reference to a flow chart shown in FIG. 7.

An output from the ground fault detector 22 disposed between each switch 23 and each photovoltaic string 10 is supplied to the lowpass filter 26 for noise reduction before supplied to the control unit 20. The control unit 20 fetches the detection outputs from the ground fault detector 22 at one-second intervals, for example (Step S1).

The control unit 20 stores the outputs fetched from the ground fault detector 22 at one-second intervals till the outputs reach a predetermined number. The control unit performs the ground fault detection process including calculating the mean value of these detection outputs and determining whether the ground fault is present or not by comparing the mean value with the set voltage (P) (Step S2). This ground fault detection process will be described hereinlater with reference to a flow chart of FIG. 7. The operation flow proceeds to Step S3. If the ground fault is absent, the operation flow returns to Step S1 to repeat the above operations.

Detecting the occurrence of the ground fault, the control unit 20 identifies the photovoltaic string 10 suffering the ground fault (Step S4). The control unit switches off the switch 23 connected to the photovoltaic string 10 suffering the ground fault, namely applies control to break the circuit (Step S5).

Subsequently, the control unit 20 stores, in the internal storage portion 204 thereof, the information concerning the occurrence of the ground fault and the photovoltaic string 10 suffering the ground fault (Step S6). Subsequently, the control unit sends out the information from the transmitter 203 to the main control unit 6 via the communication path 8, wherein the information concerns the current collecting box 2, the ground fault occurrence and the photovoltaic string 10 suffering the ground fault (Step S7). The control unit displays such information on the display unit 25 (Step S8) before completing the ground fault detection processes.

Now referring to FIG. 8, description is made on a ground fault detecting routine performed by the control unit.

First, the control unit 20 is supplied with the set voltage (P) for determining the presence of ground fault by an output from the ground fault detector 22. The detection sensitivity depends on the set voltage (P). The set voltage (P) is set inconsideration of the system, carried current and the like. It is assumed that the set voltage (p) is 10V, for example. If the control unit 20 determines the ground fault based on one output from the ground fault detector 22, the control unit may make a false detection due to unexpected noises or the like. According to the embodiment, therefore, the control unit is configured to calculate the mean value of plural detection outputs inputted thereto and to determine the presence of ground fault by comparing the mean value with the above-described set voltage (P). For this purpose, the control unit 20 fetches the detection outputs from the ground fault detector 22 at one-second intervals, for example, and stores a predetermined number of detection outputs so as to calculate the mean value thereof. In spite of the absence of the ground fault, the detection value outputted from the ground fault detector 22 progressively increases with the deterioration of the cable and the like. According to the embodiment, therefore, the detection sensitivity is adjusted by varying the number of detection signals to be averaged depending upon the value of detection output. For instance, each time the detection output value increases, the detection sensitivity is increased by reducing the number of detection outputs to be averaged. Accordingly, a mean value (D) for a detection value (D) used in this detecting routine is first calculated (S21). According to the embodiment, the number of detection outputs to be averaged is adjusted according to this detection value (D). As to the first detection value (D), the same number of detection outputs as that corresponding to the highest detection voltage (D) is fetched to calculate the mean value (D) thereof (S21). In this embodiment, the mean value of five detection outputs is calculated and used as the detection value (D).

Subsequently, determination is made as to whether this detection output is equal to or less than the lowest set value (A) or not (Step S22). This value (A) is defined to be a half of the set voltage (P), for example. A detection value on the order of half of the set voltage (P) indicates little deterioration of the cable and the like. Therefore, the detection with low sensitivity involves little problem. Specifically, if the detection voltage increases due to the noises or the like, an averaged value thereof is often less than the set voltage (P). In this embodiment, therefore, 20 detection values outputted from the ground fault detector 22 at one-second intervals are stored in the storage device and the mean value (D1) thereof is calculated (Step S23).

The control unit 20 compares the calculated mean value (D1) with the set voltage (P), determining whether or not the mean value (D1) is equal to or more than the set voltage (P) (Step S24). If the mean value is less than the set voltage (P), the control unit determines that there is no ground fault and terminates this routine.

On the other hand, if the mean value is more than the set voltage (P), the control unit detects the occurrence of a ground fault (Step S25) and terminates this routine.

If it is determined in Step S22 that the detection output exceeds the lowest set value (A), the operation flow proceeds to Step S26 (Step S26). In Step S26, the control unit determines whether or not the detection output (D) is more than A but less than B. This value (B) is defined to be 7/10 of the set voltage (P), for example. If the detection output is in this range, the cable and the like may be deteriorating a little. As compared with the case where the detection output is equal to or less than A, the detection sensitivity is increased. In this case, the control unit fetches detection values outputted from the ground fault detector 22 at one-second intervals and stores 10 detection outputs in the storage device so as to calculate the mean value (D2) thereof (Step S27). The detection output falling in the above range may indicate the sign of a minor deterioration of the cable and the like. An unexpected occurrence of failure such as ground fault can be prevented by warning that the apparatus will require some maintenance work in the near future.

The control unit 20 compares the calculated mean value (D2) with the set voltage (P), determining whether or not the mean value (D2) is equal to or more than the set voltage (P) (Step S28). If the mean value is less than the set voltage (P), the control unit determines that there is no ground fault and terminates this routine.

On the other hand, if the mean value is equal to or more than the set voltage (P), the control unit detects the occurrence of the ground fault (Step S29) and terminates this routine.

If it is determined in Step S26 that the detection output exceeds the value (B), the operation flow proceeds to Step S30. The detection output exceeding (B) indicates a high possibility of the cable and the like suffering deterioration. Therefore, the detection sensitivity is further increased. In this case, the control unit fetches the detection values outputted from the ground fault detector 22 at one-second intervals and stores 5 detection outputs in the storage device so as to calculate the mean value (D3) thereof (Step s30). The detection output falling in this range may often indicate that the cable and the like are deteriorated. An unexpected occurrence of failure such as ground fault can be prevented by warning that the apparatus requires some maintenance work.

The control unit 20 compares the calculated mean value (D3) with the set voltage (P), determining whether or not the mean value (D3) is equal to or more than the set voltage (P) (Step S31). If the mean value is less than the set voltage (P), the control unit determines that there is no ground fault and terminates this routine.

If the mean value is more than the set voltage (P), on the other hand, the control unit detects the presence of a ground fault (Step S32) and terminates this routine.

In this manner, the number of signal fetches is adjusted based on the set voltage (P) and the detection value (D). Each time the detection value (D) increases, the detection sensitivity is increased in a stepwise fashion thereby preventing the false detection and ensuring correct detection of the ground fault.

Next, a ground fault detection process by the control unit 40 of the power conditioner 4 according to the invention is described with reference to a flow chart of FIG. 9.

An output from the ground fault detector 42 is subjected to the lowpass filter (LPF) 46 for reduction of the noise component before supplied to the control unit 40. The control unit 40 fetches the detection outputs from the ground fault detector 42 at one-second intervals, for example (Step S11).

The control unit 40 performs the ground fault detection process which includes the steps of fetching the outputs from the ground fault detector 42 at one-second intervals and storing a predetermined number of fetched outputs, calculating the mean value of these detection outputs and determining whether the ground fault is present or not by comparing the mean value with the set voltage (P) (Step S12). The ground fault detection process is performed according to the same procedure as that shown in the flow chart of FIG. 7. The set voltage (P) is set in consideration of the noises of the connecting cable 3 and the like. As compared to the set voltage for the current collecting box 2, this set voltage is set to a higher value while the sensitivity is lowered.

Based on the output from the ground fault detector 42, the control unit 40 determines whether the ground fault is present or not (Step S13). If there is no ground fault, the operation flow returns to Step S11 to repeat the aforementioned operations.

When detecting the occurrence of a ground fault, the control unit 40 stops controlling the inverter 41 and deactivates the inverter 41 (Step S14). Subsequently, the control unit switches off the switch 44 so as to break the electrical connection between the power conditioner 4 and the system 5 (Step S15). Then, the control unit switches off the switch 43 thus breaking the electrical connection between the inverter 41 and the connecting cable 3 (Step s16).

Subsequently, the control unit 40 stores information concerning the occurrence of the ground fault in the internal storage device thereof (Step S17). The control unit sends out the information on the occurrence of ground fault through the communication path 8 (Step S18). The information is transmitted to the main control unit 6 via the communication path 8.

Next, another embodiment of the invention is described with reference to FIG. 10. FIG. 10 is a schematic diagram showing a principal arrangement of a photovoltaic power generation apparatus according to another embodiment of the invention. In the foregoing embodiment, the ground fault detector 22 and the ground fault detector 42 output the differential currents, respectively, while the corresponding control units 20, 40 determine the presence of a ground fault, respectively. In contrast, the embodiment shown in FIG. 10 is arranged such that the ground fault detector determines the presence of a ground fault and sends to the control unit a signal indicating the occurrence of ground fault when detecting the occurrence of the ground fault.

A ground fault detector 22′ shown in FIG. 10 detects a differential current between the forward current cable and the backward current cable and compares a detection result with a detection sensitivity value set in correlation with the detection result. If the detection value is more than the value of detection sensitivity, the detector outputs to the control unit 20 a signal indicating the occurrence of ground fault. The detection sensitivity of the ground fault detector 22′ is defined in correspondence to noise superimposed on the cable from the photovoltaic strings 10 or the like. Based on the output from the ground fault detector 22′, the control unit 20 can determine which of the photovoltaic strings 10 suffers the ground fault. After the detection of the ground fault, the control unit 20 provides the same control as that of the foregoing embodiment.

Similarly, a ground fault detector 42′ detects a differential current between the forward current cable and the backward current cable of the connecting cable 3 and compares a detection result with a detection sensitivity value set in correlation with the detection result. If the detection value is more than the value of detection sensitivity, the detector outputs to the control unit 40 a signal indicating the occurrence of a ground fault. The detection sensitivity of the ground fault detector 42′ is defined in correspondence to noise superimposed on the connecting cable 3 from the current collecting box 2 to the power conditioner 4 and the like. After the detection of the ground fault, the control unit 40 provides the same control as that of the foregoing embodiment.

Since outputs from the plural current collecting boxes 2 are collectively supplied to the power conditioner 4, the individual connecting cables 3 from the current collecting boxes 2 have different lengths according to distances therefrom. The connecting cables 3 to the power conditioner are also increased in length. Electric power supplied to the ground fault detector 42′ is superimposed with noises from the connecting cable and the like. Therefore, the detection sensitivity of the ground fault detector 42′ need be defined in consideration of the noises. The ground fault detector 22′ used in the current collecting box 2 and the ground fault detector 42′ used in the power conditioner 4 have different noises superimposed on the lines connected thereto because the lines led thereto have different lengths and locations. Because of the different noises, the detection sensitivity, which is defined in consideration of the noises, differs between the ground fault detectors 22′, 42′.

As described above, the ground fault detection may use the method wherein the ground fault detector itself detects the ground fault and the method wherein the differential current is detected and the control unit determines the presence of the ground fault based on the detection result. The ground fault detector includes the both methods.

It should be understood that the embodiments disclosed herein are to be taken as examples in every point and are not limited. The scope of the present invention is defined not by the above described embodiments but by the appended claims. All changes that fall within means and bounds of the claims or equivalence of such means and bounds are intended to be embraced by the claims.

1. A current collecting box for photovoltaic power generation serving to collect electric power from a plurality of photovoltaic strings, comprising:
a detector that detects a ground fault in each of the photovoltaic strings;
a switch provided in correspondence to each of the photovoltaic strings and interposed between the photovoltaic string and a connecting cable; and
a control unit that applies an on/off control to the switch according to a detection result supplied from the detector,
wherein upon detection of a ground fault by the detector, the control unit switches off the switch of the corresponding photovoltaic string so as to break connection between the photovoltaic string and the connecting cable.

2. The current collecting box for photovoltaic power generation according to claim 1, wherein the control unit includes a microcomputer.

3. The current collecting box for photovoltaic power generation according to claim 1, further comprising a display unit that displays information, wherein upon detection of the ground fault by the detector, the control unit causes the display unit to display information indicating the occurrence of a ground fault.

4. The current collecting box for photovoltaic power generation according to claim 3, wherein the control unit causes the display unit to display the information indicating the occurrence of ground fault together with information on the corresponding photovoltaic string.

5. The current collecting box for photovoltaic power generation according to claim 4, wherein the control unit causes the display unit to display off information on the switch corresponding to the photovoltaic string.

6. The current collecting box for photovoltaic power generation according to claim 1, further comprising a device connected with a communication path, wherein upon detection of the ground fault by the detector, the control unit transmits to the communication path information indicating the occurrence of ground fault.

7. The current collecting box for photovoltaic power generation according to claim 1, wherein the detector detects a differential current between a forward current cable and a backward current cable, compares the detection result with a detection sensitivity value set in correlation with the detection result and outputs a signal indicating the presence of ground fault if the detection result is more than the detection sensitivity value.

8. The current collecting box for photovoltaic power generation according to claim 1, wherein the detector comprises a differential current detector that detects a differential current between a forward current cable and a backward current cable, and a device that compares an output from the differential current detector with a detection sensitivity value set in correlation with the detection result.
